(19) United States
(12) Patent Application Publication
(10) Pub. No.: US 2024/0318491 A2
(43) Pub. Date: Sep. 26, 2024

(54) SLIDING WINDOW OR SLIDING DOOR ARRANGEMENT

(71) Applicant: Beat Guhl, Ottoberg (CH)

(72) Inventors: Beat GUHL, Ottoberg (CH); Stefan LANG, Kreuzlingen (CH)

(73) Assignee: Beat Guhl, Ottoberg (CH)

(21) Appl. No.: 18/233,914

(22) Filed: Aug. 15, 2023

(30) Foreign Application Priority Data
Aug. 18, 2022 (EP) 22191017.7

(51) Int. Cl. E05F 15/643

(52) U.S. Cl. CPC E05F 15/643; E05Y 2201/654; E05Y 2201/66; E05Y 2201/672

(57) ABSTRACT

A sliding window or sliding door arrangement having an external frame and a sliding element which is displaceably mounted in the external frame, a cable deflection system for tensioning and deflecting a cable, which includes a first cable deflection unit with a first cable deflection device, a second cable deflection unit with a second cable deflection device, and a guide channel which extends in the direction of gravitational force. The second cable deflection unit is held in the guide channel against gravitational force by a cable which is inserted into the cable deflection device, such that when the sliding element is displaced, the second cable deflection unit is displaced in the direction of gravitational force or in the opposing direction in the guide channel.

### CROSS-REFERENCE TO RELATED APPLICATIONS

This application claims priority from European Patent Application No. 22191017.7, filed Aug. 18, 2022, which is incorporated herein by reference as if fully set forth.

### TECHNICAL FIELD

The invention relates to a sliding window or sliding door arrangement, comprising a sliding element. The sliding window or sliding door arrangement is designed such that the sliding element can be connected by a cable to a fixed power source and in a state connected to the fixed power source can be displaced in the displacement direction relative to the fixed power source.

### BACKGROUND

In a sliding window or sliding door arrangement, the sliding element is typically mounted so as to be displaceable in a fixed external frame. The sliding element can be, for example, a sliding window or even a sliding door. There are sliding elements which provide functionalities which continuously require power during operation. Such functionalities relate, for example, to the electrical wiring of an electrically switchable pane of glass for darkening the pane of glass or making it opaque, the detection of a broken pane of glass by glass break sensors which are fastened to the sliding element or integrated therein, and display means which are attached to the sliding element or integrated in the pane of glass of a sliding element, etc. If the power is provided by a fixed power source, such as for example by a fixed power connection, the sliding element has to be connected to the fixed power source such that the sliding element is continually connected to the fixed power source during operation.

The document WO 2022/047071 A1 discloses a sliding window or sliding door arrangement in which the sliding element is connected to a fixed power source via a wireless connection.

The document WO 2022/047071 A1 also discloses a sliding window or sliding door arrangement in which the sliding element is connected to a fixed power source via a powered guide chain system.

### SUMMARY

It is the object of the invention to provide a sliding window or sliding door arrangement in which the sliding element can be reliably and simply connected to a fixed power source and the connectibility can be provided in a tight space.

The object is achieved by a sliding window or sliding door arrangement having one or more of the features of disclosed herein. Preferred embodiments of the sliding window or sliding door arrangement are described below and in the claims.

The invention relates to a sliding window or sliding door arrangement, comprising an external frame and a sliding element which is displaceably mounted in the external frame, and a cable deflection system for tensioning and deflecting a cable, comprising a first cable deflection unit with a first cable deflection device, a second cable deflection unit with a second cable deflection device, and a guide channel which extends in the direction of gravitational force, wherein the first cable deflection unit is designed such that, for tensioning and deflecting a cable, the cable can be inserted into the first cable deflection device and the first cable deflection unit is mounted in a positionally fixed manner on the sliding window or sliding door arrangement relative to a movement in the direction of gravitational force, such that a cable which is inserted into the first cable deflection device is deflected about a first deflection axis in the direction of gravitational force, and the second cable deflection unit is designed such that, for tensioning and deflecting a cable, the cable can be inserted into the second cable deflection device and the second cable deflection unit is arranged in the guide channel so as to be displaceable in the guide channel, such that when the cable is inserted into the first and second cable deflection device, which cable being fastened to the sliding element and to a fixed power source and connecting the sliding element to the fixed power source, the second cable deflection unit is held in the guide channel against gravitational force by the cable and, when the sliding element is displaced, the second cable deflection unit is displaced in the direction of gravitational force or in the opposing direction in the guide channel, and the cable is deflected about a second deflection axis in the direction of the first cable deflection unit, and the second cable deflection unit comprises a weight such that, when the sliding element is displaced, the second cable deflection unit and the weight are displaced in the direction of gravitational force or in the opposing direction in the guide channel, and the cable deflection system is designed to tension a cable, which connects the sliding element to a fixed power source, by the constant weight force of the weight and, when the sliding element is displaced, to deflect thereby the cable which is tensioned by a uniformly constant tensioning force.

Such a sliding window or sliding door arrangement is typically inserted into an opening provided therefor in a wall of a structure. The external frame is fitted into this opening such that the sliding window or sliding door arrangement can be opened by sliding the sliding element in the displacement direction in the longitudinal direction of the external frame. The external frame serves, amongst other things, for receiving, fastening, mounting and guiding the sliding element and also possible further elements which can also be arranged in a positionally fixed manner in the external frame. The sliding element and also further elements of the sliding window or sliding door arrangement can have in each case an element frame which is thus arranged in the external frame.

The cable deflection system can be arranged in the external frame or both in the external frame and in an element frame. The cable deflection system can be designed as a kit such that existing sliding window or sliding door arrangements can be fitted with a cable deflection system.

The cable can be a power cable. The power cable comprises insulation and a conductor. When a power cable is tensioned and deflected by the cable deflection system, the insulation is in direct contact with the cable deflection system. Forces occurring during the tensioning and deflection are transmitted from the cable deflection system via the insulation to the conductor.

“Tensioning” a cable means that the cable is forced into a more rectilinear cable path between two cable fixing points and/or cable deflection points due to a force acting externally on the cable.

“Deflection” means that—following along the cable from one end to the other end—the direction of the path of the cable is changed by deflection.

The guide channel can be a part of the external frame or a part of an element frame, which part extends in the direction of gravitational force. If the guide channel is a part of the external frame, it is fixed. If the guide channel is part of an element frame, it can be displaced in the direction of displacement relative to the external frame.

The guide channel can comprise at least two, preferably three, or particularly preferably four, guide channel walls. If the guide channel comprises two guide channel walls, they can run parallel to one another and spaced apart from one another or transversely, in particular at right angles, to one another. If the guide channel comprises three guide channel walls, the guide channel can be designed in the shape of a U-shaped profile. If the guide channel comprises four guide channel walls, the guide channel can be designed in the shape of a tubular profile.

“Can be inserted into a cable deflection device” means that the cable deflection unit is designed such that a cable, which is fastened to the sliding element and to a fixed power source and thus connects the sliding element to the fixed power source, can be inserted into the cable deflection device when a connection is already present. In other words, for the insertion process the fastening of the cable does not have to be released from the sliding element or from the fixed power source. To this end, the cable deflection unit can comprise an opening toward the cable deflection device, via which the cable can be inserted in a guided manner into the cable deflection device. Moreover, a cable deflection device can comprise a channel into which a cable to be deflected can be inserted, wherein the cable is guided and held in the channel when deflected.

If the guide channel is a part of the external frame, the first cable deflection unit can be mounted in a positionally fixed manner in the direction of gravitational force via the guide channel on the external frame relative to a movement in the direction of gravitational force. If the guide channel is a part of an element frame, the first cable deflection unit can be mounted in a positionally fixed manner in the direction of gravitational force via the guide channel on the element frame relative to a movement in the direction of gravitational force.

“Mounted in a positionally fixed manner relative to a movement in the direction of gravitational force” means that the first cable deflection unit is fixedly mounted on the sliding window or sliding door arrangement such that the first cable deflection unit is fixed in the direction of gravitational force.

The deflection axis of a cable deflection device runs transversely, in particular at right angles, to a plane in which the cable passes through the cable deflection device.

If the cable is inserted into the first and second cable deflection device, then the cable coming from the sliding element is deflected by the first cable deflection device about the first deflection axis in the direction of gravitational force and in the direction of the second cable deflection device, and deflected by the second cable deflection device about the second deflection axis in the direction of the first cable deflection unit and counter to the direction of the gravitational force. In this case, the cable forms a U-shaped region where the cable is deflected by the second cable deflection device. The second cable deflection unit is held in the valley of the U-shaped region against gravitational force by the cable, such that when the cable is at rest the second cable deflection unit does not move in the direction of gravitational force.

When the sliding element is displaced, the U-shaped region moves and together therewith the second cable deflection unit in the guide channel in the direction of gravitational force or in the opposing direction. If the sliding element moves toward the fixed power source, for example, then the second cable deflection unit moves in the direction of gravitational force. If the sliding element moves away from the fixed power source, for example, then the second cable deflection unit is displaced in the direction opposing the direction of gravitational force.

The sliding window or sliding door arrangement according to the invention thus permits a reliable and simple cable connection of the sliding element to a fixed power source. The cable deflection system can be designed in a simple and compact manner, such that the connectibility can be provided in a tight space. The cable is able to be tensioned by the constant weight force of the weight encompassed by the second cable deflection device, and namely irrespective of the position of the second cable deflection unit in the guide channel. In other words, the cable can be tensioned thereby with the same constant force irrespective of the position of the second cable deflection unit in the guide channel.

In order to achieve the sliding window or sliding door arrangement according to the invention, in a first inventive step it has been recognized that the current or voltage characteristic on the sliding element is important for certain power-consuming functionalities of a sliding element, for example darkening a switchable pane of glass of a sliding element. In other words, the current or voltage characteristic has to fulfil certain requirements for reliably providing specific power-based functionalities.

In a further inventive step, it has been recognized that it is important that the cable connection is designed to be able to be provided in compact form, such that it can be integrated in conventional sliding window or sliding door arrangements.

In a further inventive step, it has been recognized that the cable connection is able to be provided by a cable deflection system which deflects in a tensioned manner a cable which connects a sliding element to a fixed power source. It has been recognized that it is important for the long-term stability of the cable connection that the cable is tensioned with a uniformly constant tensioning force during operation. It has been recognized that the cable can be tensioned by a weight which can be fastened to the cable deflection system.

According to one embodiment of the sliding window or sliding door arrangement, the second cable deflection unit comprises a fastening device, the weight being able to be fastened thereby to the second cable deflection unit.

According to one embodiment of the sliding window or sliding door arrangement, the cable deflection system comprises an elongated cable support element which, when the cable is inserted into the first and second cable deflection device, which cable being fastened to the sliding element and to a fixed power source and connecting the sliding element to the fixed power source, is arranged between the sliding element and the cable, runs parallel to the displacement direction of the sliding element and extends over the length of a maximum possible displacement path of the sliding element.

The elongated cable support element supports a cable inserted into the first and second cable deflection device such that the tensioned cable is restricted by the elongated cable support element from sagging down, even with a displacement of the sliding element over a distance which corresponds to the maximum possible displacement path of the sliding element.

The elongated cable support element can be fastened to the external frame or to the sliding element. The elongated cable support element can be flexible.

According to one embodiment of the sliding window or sliding door arrangement, the cable deflection system has a cable guiding element which is fastened to the sliding element and is displaceably mounted on the elongated cable support element, such that a cable, which connects the sliding element to a fixed power source, can be guided by the cable guiding element between the elongated cable support element and the external frame and, when the sliding element is displaced, the cable guiding element is displaced along the elongated cable support element.

The cable guiding element guides the cable between the external frame and the elongated cable support element such that the tensioned cable is restricted by the elongated cable support element from sagging down.

The cable guiding element can be a correspondingly shaped sheet metal element to which a cable can be fastened for the guiding.

The cable guiding element can have recesses for guiding through a connecting element, wherein a cable positioned on the cable guiding element can be fastened by the connecting element to the cable guiding element. The connecting element can be a metallic or polymer-based strip. The connecting element can be, for example, a cable tie.

According to one embodiment of the sliding window or sliding door arrangement, the elongated cable support element is an elongated U-shaped profile and the cable guiding element comprises an angled-back surface region, the cable guiding element being hooked thereby into the U-shaped profile.

The elongated U-shaped profile guides the cable guiding element, supports a cable inserted into the first and second cable deflection device and holds such a cable captively in a direction transversely to the longitudinal direction of the U-shaped profile between the two parallel profile walls.

The cable guiding element can be designed such that it can be displaceably fastened to the U-shaped profile by inserting the front face of the angled-back surface region into the U-shaped profile. This fastening permits a displaceability of the cable guiding element along the elongated cable support element.

According to one embodiment of the sliding window or sliding door arrangement, the second cable deflection unit is arranged with the second deflection axis transversely, in particular at right angles, to the first deflection axis and transversely, in particular at right angles, to the direction of gravitational force in the guide channel.

As a result, a space-saving arrangement of the cable deflection system is achieved.

The second deflection axis can run at right angles to the first deflection axis.

According to one embodiment of the sliding window or sliding door arrangement, the first cable deflection unit has a maximum extent A in a direction transversely, in particular at right angles, to the first deflection axis and parallel to the displacement direction of the sliding element and the second cable deflection unit has a maximum extent B of 0.5 A≤B≤2.0 A in a direction parallel to the second deflection axis.

As a result, a space-saving arrangement of the cable deflection system is achieved.

According to one embodiment of the sliding window or sliding door arrangement, the first cable deflection unit has a fastening element which is designed to fix a region of a cable to the first cable deflection unit.

As a result, a cable, which connects the sliding element to a fixed power source and is inserted into the first and second cable deflection device, can be fixed to the first cable deflection unit. As a result, the cable can be clamped between the fastening element of the first cable deflection unit and a fastening point on the sliding element. The constant weight force thus does not act on the connecting point at which the cable is connected to the fixed power source.

The fastening element can comprise recesses for guiding through a connecting element, wherein a region of the cable positioned on the first cable deflection unit can be fixed by the connecting element to the first cable deflection unit. The connecting element can be a metallic or polymer-based strip. The connecting element can be, for example, a cable tie.

According to one embodiment of the sliding window or sliding door arrangement, the first and second cable deflection unit in each case have a housing and a housing part of the respective housing protrudes over the respective first and second cable deflection device, such that a cable inserted into the first and second cable deflection device is captured in a direction along the respective first and second deflection axis.

As a result, a cable inserted into the first and second cable deflection device is securely guided and held during the deflection.

The housing of the second cable deflection unit can be in two parts, wherein the two parts can be plugged together. Thus the housing of the second cable deflection unit can be separated into two parts in order to insert a cable into the second cable deflection device and can be plugged together in order to secure in the second cable deflection device the cable which has been inserted into the second cable deflection device.

According to one embodiment of the sliding window or sliding door arrangement, the second cable deflection unit has ribs on the housing, the ribs protruding from the housing and being designed to guide the second cable deflection unit in the guide channel.

The ribs can be arranged on a first housing wall which extends transversely, in particular at right angles, to the second deflection axis and/or on a further housing wall which extends transversely, in particular at right angles, to the first housing wall.

According to one embodiment of the sliding window or sliding door arrangement, the first cable deflection unit has a third cable deflection device which is designed to deflect a cable inserted therein about a third deflection axis which runs obliquely to the first deflection axis, and the second cable deflection unit has a fourth cable deflection device which is designed to deflect a cable inserted therein about the second deflection axis and is arranged spaced apart from the second cable deflection device.

As a result, a cable inserted into the first, second, third and fourth cable deflection device is deflected four times, whereby a longer cable can be tensioned and deflected in a tensioned manner within the same length of the guide channel.

According to one embodiment of the sliding window or sliding door arrangement, the first deflection axis runs in a first plane which extends transversely, in particular at right angles, to the direction of gravitational force, the third deflection axis runs in a further plane parallel to the first plane and spaced apart from the first plane, and a normal projection of the first deflection axis onto the further plane encloses an angle alpha of 45°≤alpha≤90° with the third deflection axis.

As a result, a space-saving arrangement of the cable deflection system is achieved.

According to one embodiment of the sliding window or sliding door arrangement, at least one cable deflection device is a deflection roller which is rotatably mounted about the deflection axis, or each cable deflection device is a deflection roller which is rotatably mounted about the deflection axis.

As a result, a cable can be deflected substantially without friction.

A deflection roller can have a channel which runs along the circumference and into which a cable can be inserted.

According to one embodiment of the sliding window or sliding door arrangement, the fastening device is a suspension device comprising a projection which is designed such that a weight can be hooked into and unhooked from the projection.

As a result, a weight tailored to the cable to be deflected can be fastened to the second cable deflection unit, wherein the tailored uniform weight force sufficiently tensions the cable to be deflected.

The fastening device can have an opening which extends in a direction parallel to the second deflection axis, such that the weight can be hooked into and unhooked from the suspension device by inserting the weight into the opening.

According to one embodiment of the sliding window or sliding door arrangement, the sliding window or sliding door arrangement has a cable, wherein the cable is fastened to the sliding element and to the fixed power source, the cable connects the sliding element to the fixed power source and the cable is deflected in a tensioned manner by the constant weight force of the weight.

According to one embodiment of the sliding window or sliding door arrangement, the first and the second cable deflection unit are configured in each case in one piece. The first and the second cable deflection unit can be produced from plastics by means of an additive method, such that assembly steps are dispensed with.

### BRIEF DESCRIPTION OF THE DRAWINGS

The sliding window or sliding door arrangement according to the invention is described in more detail hereinafter purely by way of example using specific embodiments shown in the figures, in which:

FIG. 1 shows the parts of a cable deflection system and a sliding element according to one embodiment of the sliding window or sliding door arrangement; and

FIG. 2 shows a first cable deflection unit and a second cable deflection unit according to one embodiment of the sliding window or sliding door arrangement.

### DETAILED DESCRIPTION

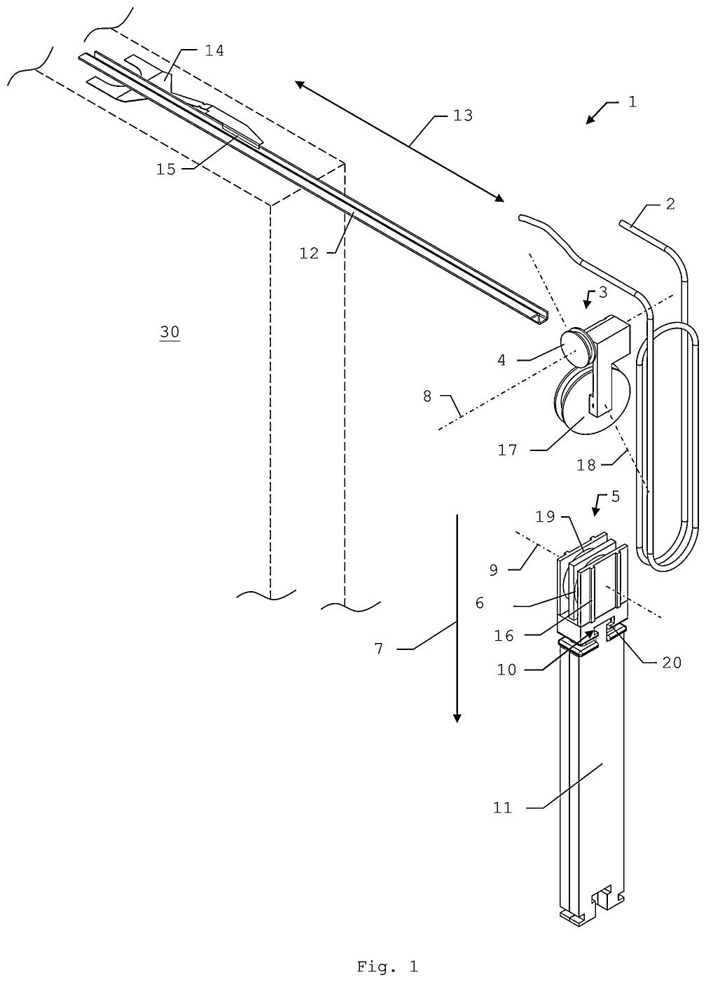

FIG. 1 shows the parts of a cable deflection system 1 and a sliding element 30 of an embodiment of the sliding window or sliding door arrangement. In order to show the parts more clearly, the parts are shown offset to one another. The cable deflection system 1 can be designed as a kit such that existing sliding window or sliding door arrangements can be fitted therewith. The sliding element 30 which is displaceably mounted in the external frame is indicated in FIG. 1. The guide channel is not shown in FIG. 1.

The cable deflection system 1 shown in FIG. 1 comprises an elongated cable support element 12. The elongated cable support element 12 is an elongated U-shaped profile.

The cable deflection system 1 shown in FIG. 1 also comprises a cable guiding element 14 which can be fastened to the sliding element 30 and which is displaceably mounted on the elongated cable support element 12. The cable guiding element 14 comprises an angled-back surface region, the cable guiding element 14 being hooked thereby into the U-shaped profile. When the sliding element 30 is displaced, the cable guiding element 14 is displaced along the elongated cable support element 12.

A cable 2 which is fastened to the sliding element 30 can be fastened to the cable guiding element and thus can be guided between the elongated cable support element 12 and the external frame. The cable 2 thus runs between the elongated cable support element 12 and the external frame, such that the tensioned cable 2 is restricted by the elongated cable support element 12 from sagging down, even with a displacement of the sliding element 30 over a distance which corresponds to the maximum possible displacement path.

The sliding window or sliding door arrangement is also able to be implemented without the cable support element and without the cable guiding element. Then the cable has to be tensioned such that the tensioned cable is intentionally restricted by the tension of the cable from sagging down. “Intentionally” can mean that the cable does not protrude from the external frame. In other words, the tensioned cable is not visible during operation, i.e. even when the sliding element is displaced. The second cable deflection unit 5 is thus arranged in the guide channel, not shown, such that the second deflection axis 9 runs transversely to the first deflection axis 8 and transversely to the direction of gravitational force 7.

The second cable deflection unit 5 has ribs 16 on the housing, the ribs protruding from the housing and being designed to guide the second cable deflection unit 5 in the guide channel.

The first cable deflection unit 3 has a third cable deflection device 17 which is designed to deflect the cable 2 inserted therein about a third deflection axis 18 which runs obliquely to the first deflection axis 8.

The second cable deflection unit 5 has a fourth cable deflection device 19 which is designed to deflect the cable 2 inserted therein about the second deflection axis 9 and which is arranged spaced apart from the second cable deflection device 6.

The first deflection axis 8 runs in a first plane which extends transversely to the direction of gravitational force 7. The third deflection axis 18 runs in a further plane parallel to the first plane and spaced apart from the first plane. A normal projection of the first deflection axis 8 onto the further plane encloses an angle of 45°≤alpha≤90° with the third deflection axis 18.

The cable deflection devices 4, 6, 17, 19 are in each case a deflection roller, rotatably mounted about the respective deflection axis 8, 9, 18.

The fastening device 10 is a suspension device with a projection 20. The suspension device is designed such that a weight 11 can be hooked into and unhooked from the projection 20.

The fastening device 10 has an opening which extends in a direction parallel to the second deflection axis such that the weight 11 can be hooked into and unhooked from the suspension device by inserting the weight 11 into the opening.

The cable deflection system 1 comprises the cable 2 and the weight 11, wherein the cable 2 can be fastened to the sliding element 30 and to the fixed power source, and the sliding element 20 can be connected to the fixed power source and can be tensioned and deflected in a tensioned manner by the weight 11.

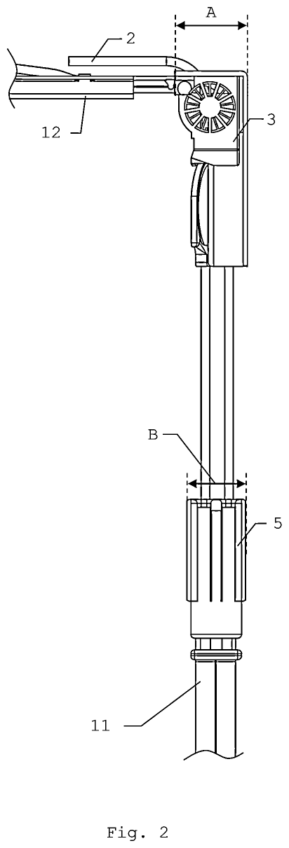

FIG. 2 shows a first cable deflection unit 3 and a second cable deflection unit 5 according to one embodiment of the sliding window or sliding door arrangement. In order to show the parts more clearly, the parts are shown offset to one another. The first cable deflection unit 3 has a maximum extent A in a direction transversely to the first deflection axis 8 and parallel to the displacement direction 13 of the sliding element 30 and the second cable deflection unit 5 has a maximum extent B of 0.5 A≤B≤2.0 A in a direction parallel to the second deflection axis 9.

The first and the second cable deflection unit 3, 5 are configured in each case in one piece and comprise a housing.

1. A sliding window or sliding door arrangement, comprising:
an external frame and a sliding element (30) which is displaceably mounted in the external frame;
a cable deflection system (1) for tensioning and deflecting a cable (2), the cable tensioning system comprising
a first cable deflection unit (3) with a first cable deflection device (4),
a second cable deflection unit (5) with a second cable deflection device (6), and
a guide channel which extends in the direction of gravitational force (7);
wherein
the first cable deflection unit (3) is configured such that, for tensioning and deflecting the cable (2), with the cable (2) being insertable into the first cable deflection device (4), and
the first cable deflection unit is mounted in a positionally fixed manner on the sliding window or sliding door arrangement relative to a movement in the direction of gravitational force (7), such that the cable (2) which is inserted into the first cable deflection device (4) is deflected about a first deflection axis (8) in the direction of gravitational force (7);
the second cable deflection unit (5) is configured such that, for tensioning and deflecting the cable (2), with the cable (2) being insertable into the second cable deflection device (6) and the second cable deflection unit is arranged in the guide channel so as to be displaceable in the guide channel,
such that upon the cable (2) being inserted into the first and second cable deflection devices (4, 6), said cable being fastened to the sliding element (30) and to a fixed power source and connecting the sliding element (30) to the fixed power source, the second cable deflection unit (5) is held in the guide channel against gravitational force by the cable (2);
upon the sliding element (30) being displaced, the second cable deflection unit (5) is displaced in the direction of gravitational force (7) or in an opposing direction in the guide channel,
the cable (2) being deflectable about a second deflection axis (9) in the direction of the first cable deflection unit (3), and
the second cable deflection unit comprises a weight (11) such that, upon the sliding element (30) being displaced, the second cable deflection unit (5) and the weight (11) are displaced in the direction of gravitational force or in the opposing direction in the guide channel; and
the cable deflection system (1) is adapted to tension the cable (2), which connects the sliding element (30) to the fixed power source, by a constant weight force of the weight (11) and, upon the sliding element (30) being displaced, to deflect thereby the cable (2) which is tensioned by a uniformly constant tensioning force.

2. The sliding window or sliding door arrangement as claimed in claim 1, wherein the second cable deflection unit (5) comprises a fastening device (10), the weight (11) being fastenable via the fastening device (10) to the second cable deflection unit (5).

3. The sliding window or sliding door arrangement as claimed in claim 1, wherein the cable deflection system comprises an elongated cable support element (12) which, upon the cable (2) being inserted into the first and second cable deflection device (4, 6), said cable being fastened to the sliding element (30) and to the fixed power source and connecting the sliding element (30) to the fixed power source, is arranged between the sliding element (30) and the cable (2), runs parallel to the displacement direction (13) of the sliding element (30), and extends over a length of a maximum possible displacement path of the sliding element (30).

4. The sliding window or sliding door arrangement as claimed in claim 3, wherein the cable deflection system (1) further comprises a cable guiding element (14) which is fastened to the sliding element (30) and is displaceably mounted on the elongated cable support element (12), such that the cable (2), which connects the sliding element (30) to the fixed power source, is guided by the cable guiding element (14) between the elongated cable support element (12) and the external frame and, upon the sliding element (30) being displaced, the cable guiding element (14) is displaced along the elongated cable support element (12).

5. The sliding window or sliding door arrangement as claimed in claim 4, wherein the elongated cable support element (12) is an elongated U-shaped profile and the cable guiding element (14) comprises an angled-back surface region (15), with the cable guiding element (14) being hooked the angled-back surface region (15) into the U-shaped profile.

6. The sliding window or sliding door arrangement as claimed in claim 1, wherein the second cable deflection unit (5) is arranged with the second deflection axis (9) transversely to the first deflection axis (8) and transversely to the direction of gravitational force (7) in the guide channel.

7. The sliding window or sliding door arrangement as claimed in claim 6, wherein the first cable deflection unit (3) has a maximum extent A in a direction transversely to the first deflection axis (8) and parallel to the displacement direction (13) of the sliding element (30) and the second cable deflection unit (5) has a maximum extent B of 0.5 A≤B≤2.0 A in a direction parallel to the second deflection axis (9).

8. The sliding window or sliding door arrangement as claimed in claim 1, wherein the first cable deflection unit (3) has a fastening element configured to fix a region of a cable (2) to the first cable deflection unit (3).

9. The sliding window or sliding door arrangement as claimed in claim 1, wherein the first and second cable deflection unit (3, 5) in each case have a housing and a housing part of the respective housing protrudes over the respective first and second cable deflection device (4, 6), such that the cable (2) inserted into the first and second cable deflection device (4, 6) is captured in a direction along the respective first and second deflection axis (8, 9).

10. The sliding window or sliding door arrangement as claimed in claim 9, wherein the second cable deflection unit (5) has ribs (16) on the housing, the ribs protruding from the housing and being adapted to guide the second cable deflection unit (5) in the guide channel.

11. The sliding window or sliding door arrangement as claimed in claim 1, wherein the first cable deflection unit (3) has a third cable deflection device (17) which is adapted to deflect the cable (2) inserted therein about a third deflection axis (18) which runs obliquely to the first deflection axis (8), and the second cable deflection unit (5) has a fourth cable deflection device (19) which is adapted to deflect the cable (2) inserted therein about the second deflection axis (9) and is arranged spaced apart from the second cable deflection device (6).

12. The sliding window or sliding door arrangement as claimed in claim 11, wherein the first deflection axis (8) runs in a first plane which extends transversely to the direction of gravitational force (7), the third deflection axis (18) runs in a further plane parallel to the first plane and spaced apart from the first plane, and a normal projection of the first deflection axis (8) onto the further plane encloses an angle alpha of 45°≤alpha≤90° with the third deflection axis (18).

13. The sliding window or sliding door arrangement as claimed in 11, wherein at least one of the first, second, third or fourth cable deflection devices (4, 6, 17, 19) comprises a deflection roller which is rotatably mounted about the respective deflection axis (8, 9, 18).

14. The sliding window or sliding door arrangement as claimed in 11, wherein each of the first, second, third or fourth cable deflection devices (4, 6, 17, 19) comprises a deflection roller which is rotatably mounted about the respective deflection axis (8, 9, 18).

15. The sliding window or sliding door arrangement as claimed in claim 2, wherein the fastening device (10) is a suspension device comprising a projection (20) which is adapted to have the weight (11) hooked into and unhooked therefrom.

16. The sliding window or sliding door arrangement as claimed in claim 1, wherein the sliding window or sliding door arrangement includes the cable (2) and the cable (2) is fastened to the sliding element (30) and to the fixed power source, the cable connects the sliding element (30) to the fixed power source and the cable is deflected in a tensioned manner by the constant weight force of the weight (11).

17. The sliding window or sliding door arrangement as claimed in claim 1, wherein the first and the second cable deflection units (3, 5) are each configured in one piece.
